(19) United States
(12) Patent Application Publication
(10) Pub. No.: US 2009/0327750 A1
(43) Pub. Date: Dec. 31, 2009

(54) SECURITY SYSTEM FOR CODE DUMP PROTECTION AND METHOD THEREOF

(76) Inventors: Tse-Hong Wu, Hsinchu City (TW); Yao-Dun Chang, Hsinchu City (TW); Wan-Perng Lin, Taipei City (TW); Yeow-Chyi Chen, Taipei County (TW); Yung-Sheng Chiu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/164,097

(22) Filed: Jun. 29, 2008

(51) Int. Cl. H04L 9/06

(52) U.S. Cl. 713/189

(57) ABSTRACT

A security system for code dump protection includes a storage device, a processor, and a decryption unit. The storage device has a protected storage area storing at least an encrypted code segment. The processor is utilized for issuing at least one address pattern to the storage device for obtaining at least one information pattern corresponding to the address pattern. The decryption unit checks signal communicated between the processor and the storage device to generate a check result, and determines whether to decrypt the encrypted code segment in the protected storage area to generate a decrypted code segment to the processor according to the check result.

### BACKGROUND

The present invention relates to a security system, and more particularly, to a security system for code dump protection and a method thereof.

Please refer to FIG. 1. FIG. 1 is a diagram of a conventional system 100 without security protection. Generally speaking, code segments that are going to be executed by the microprocessor 105 are stored in the memory 110, such as a flash memory. When the system 100 operates, the microprocessor 105 issues an address signal having an address pattern to the memory 110 via pins of the IC chip 115 and a related bus for fetching a specific code segment stored in the memory 110. After interpretation, the specific code segment is usually a specific instruction used by the microprocessor 105. The microprocessor 105 uses the specific instruction to execute various actions or data processing. The specific code segment stored in the memory 110, however, is not encrypted. Hackers can easily read the specific code segment from the memory 110 to know how the microprocessor 105 executes the specific code segment.

Please refer to FIG. 2. FIG. 2 is a diagram of a secret system 200 with a conventional code protection scheme. The memory 210 includes a protected storage area 210b and other unprotected storage areas 210a and 210c where the protected storage area 210b stores encrypted code segments. Normally, when the microprocessor 205 fetches data stored in the storage areas 210a and 210c, the fetched data is directly transmitted to the microprocessor 205 via the same bus without undergoing additional processing. When the microprocessor 205 fetches data (i.e. encrypted code segments) stored in the protected storage area 210b via the bus, a decryption unit 220 firstly decrypts the fetched data and then transmits decrypted data (e.g. decrypted code segments) to the microprocessor 205 which the microprocessor 205 can then interpret. There is still, however, a high possibility that hackers can retrieve the decrypted data.

Please refer to FIG. 3, which illustrates how hackers modify data stored in the storage area 210a or 210c shown in FIG. 2 to dump the decrypted data buffered in the microprocessor 205. Since hackers cannot obtain the content of the encrypted code segments by directly accessing the encrypted code segments, they may modify an instruction within the storage area 210a where the modified instruction (i.e. ‘data dump’) is used to dump the decrypted code segments buffered in the microprocessor 205 to an external memory 235. Thus, the hackers can easily get content of the encrypted code segment stored in the protected storage area 210b.

### SUMMARY

Therefore, one of the objectives of the present invention is to provide a security system for code dump protection and a method thereof, to solve the above-mentioned problems.

According to an embodiment of the present invention, a security system for code dump protection is disclosed. The security system comprises a storage device, a processor, and a decryption unit. The storage device has a protected storage area, and the protected storage area stores at least an encrypted code segment. The processor is utilized for issuing at least one address pattern to the storage device for obtaining at least an information pattern corresponding to the address pattern. The decryption unit is coupled between the processor and the storage device; the decryption unit is utilized for checking data communicated between the processor and the storage device to generate a check result, and for determining whether to decrypt the encrypted code segment in the protected storage area to generate a decrypted code segment to the processor according to the check result.

According to an exemplary embodiment of the present invention, a security method for code dump protection in a security system is disclosed. The security method comprises the following steps of: providing a storage device having a protected storage area for storing at least an encrypted code segment; utilizing a processor to issue at least one address pattern to the storage device for obtaining at least an information pattern corresponding to the address pattern; checking data communicated between the processor and the storage device to generate a check result; and determining whether to decrypt the encrypted code segment in the protected storage area to generate a decrypted code segment to the processor according to the check result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional system without security protection.

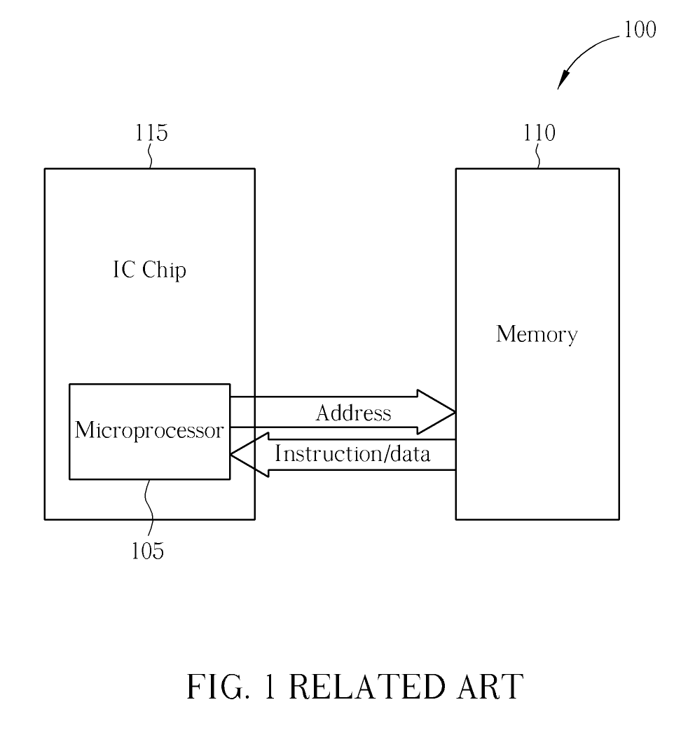

FIG. 2 is a diagram of a secret system with a conventional code protection scheme.

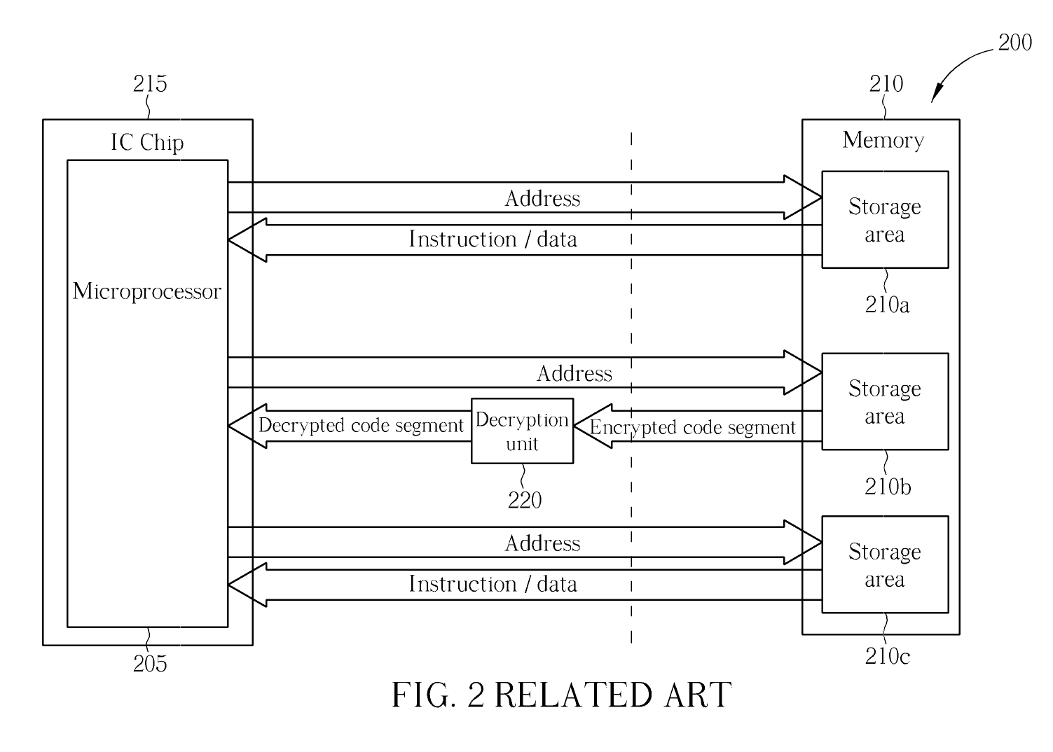

FIG. 3 is a diagram illustrating how hackers can modify data stored in a storage area to dump the decrypted data buffered in a microprocessor shown in FIG. 2.

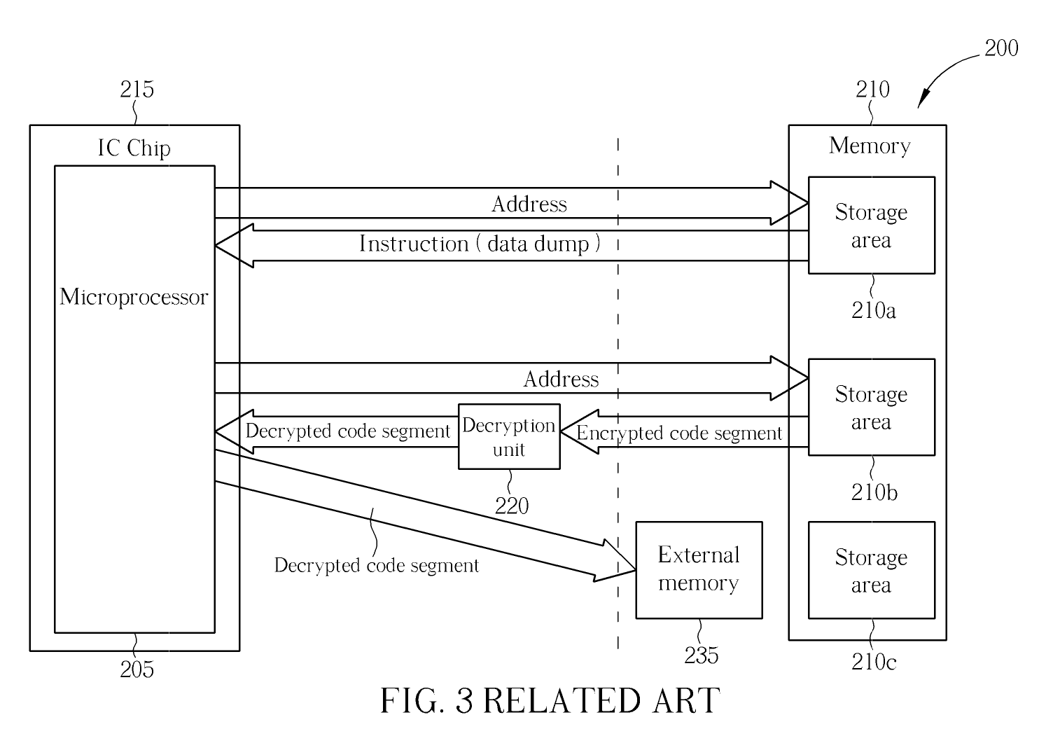

FIG. 4A is a diagram of a security system for code dump protection according to an embodiment of the present invention.

FIG. 4B is a diagram illustrating how a decryption unit directly transmits code segments in a protected storage area of the security system to a microprocessor shown in FIG. 4A.

FIG. 4C is a diagram illustrating that the decryption unit does not transmit code segments in the protected storage area of the security system to the microprocessor shown in FIG. 4A.

FIG. 5 is a diagram illustrating a first example of designing predetermined address patterns and predetermined information patterns.

FIG. 6 is a diagram illustrating a second example of designing predetermined address patterns and predetermined information patterns.

FIG. 7 is a diagram illustrating a third example of designing predetermined address patterns and predetermined information patterns.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

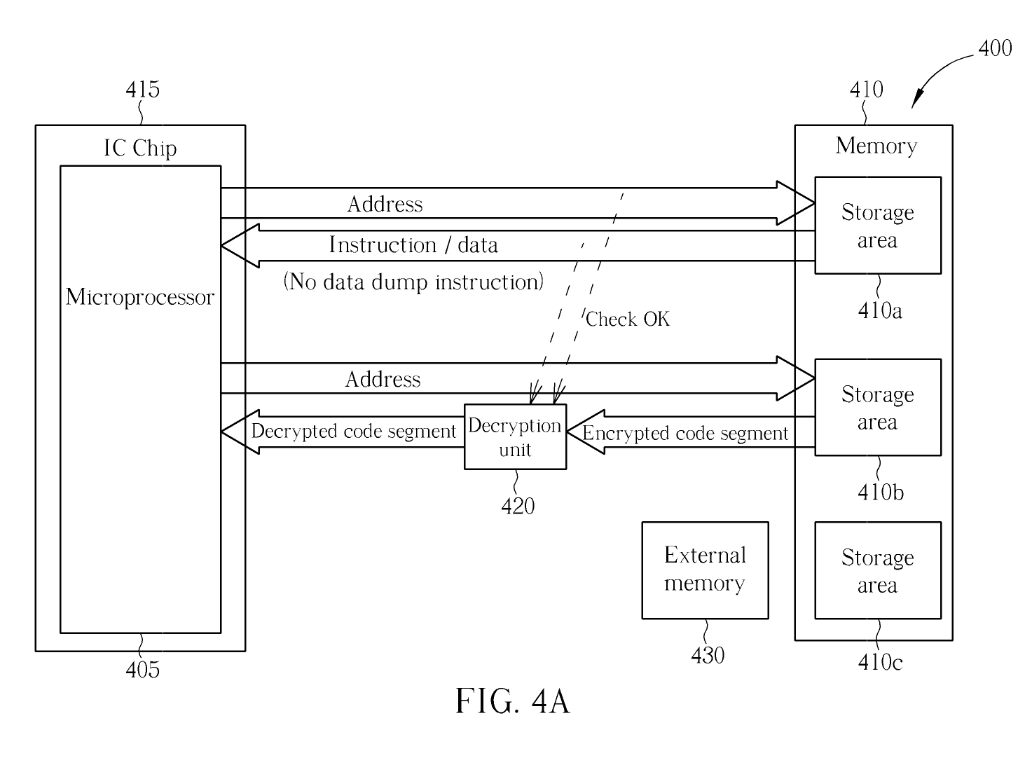

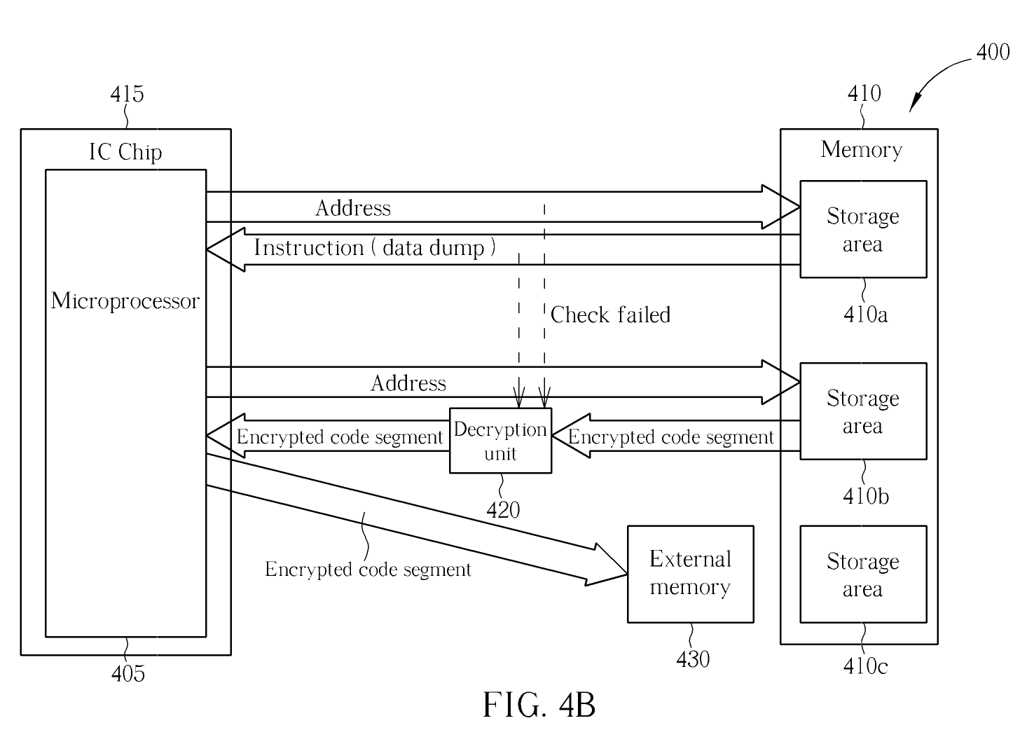

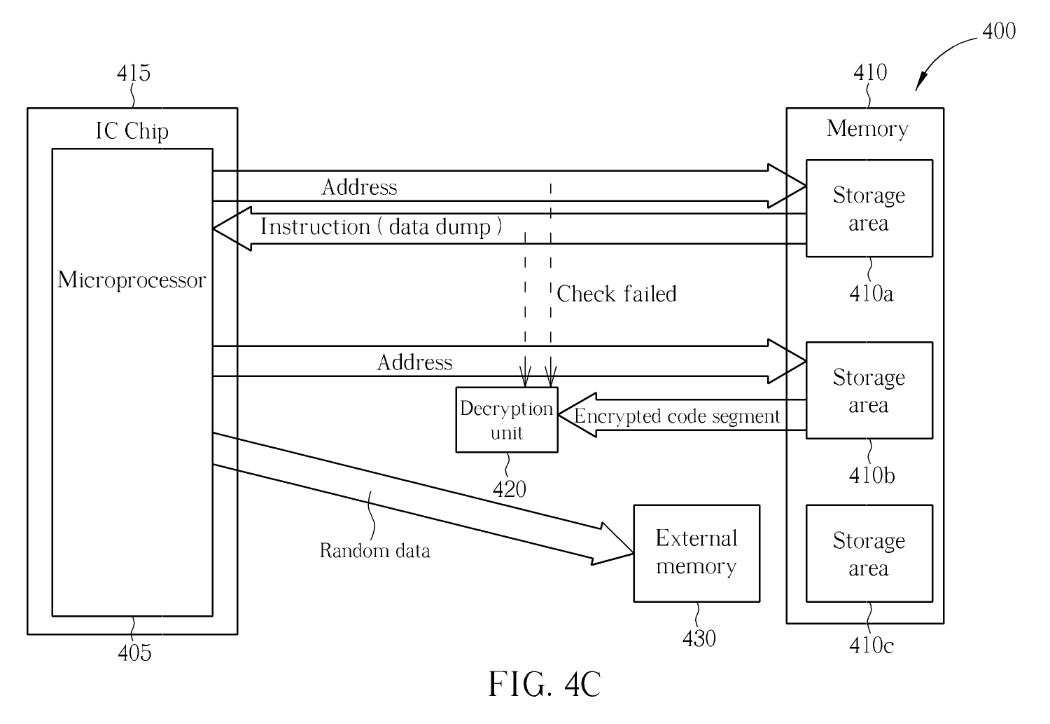

Please refer to FIG. 4A. FIG. 4A is a diagram of a security system 400 for code dump protection according to an embodiment of the present invention. The security system 400 includes a microprocessor (a kind of processor) 405, a storage device (e.g. a flash memory) 410, and a decryption unit 415. The storage device 410 has a protected storage area 410b and two unprotected storage areas 410a and 410c where the protected storage area 410b stores encrypted code segment(s). When the microprocessor 405 issues at least an address pattern to the storage device 410 for fetching at least an information pattern corresponding to the address pattern, the decryption unit 415 checks signal communicated between the microprocessor 405 and the storage device 410 to generate a check result. The decryption unit 415 then determines whether to decrypt an encrypted code segment in the protected storage area 410b to generate a decrypted code segment to the microprocessor 405 according to the check result. In this embodiment, the signal communicated between the microprocessor 405 and the storage device 410 can be the address pattern issued by the microprocessor 405 or the fetched information pattern. That is, the decryption unit 415 checks either the address pattern or the information pattern or checks both to generate the check result. The address pattern comprises a pattern of an address, a pattern of an address header, or both, and the decryption unit 415 can generate the check result by checking the pattern of address, the pattern of address header, or both. Also, the fetched information pattern comprises an instruction pattern, a data pattern, or both, and the decryption unit 415 can generate the check result by checking the instruction pattern, the data pattern, or both. All of the above-mentioned modifications fall within the scope of the present invention.

In FIG. 4A, when the check result indicates that the address pattern matches a predetermined address pattern or the information pattern matches a predetermined information pattern, the decryption unit 415 decrypts the encrypted code segment to generate a decrypted code segment and transmits the decrypted code segment to the microprocessor 405. Since the predetermined information pattern (e.g. an instruction pattern) is not designed to be a ‘data dump’ instruction by designers, the decryption unit 415 is enabled to decrypt the encrypted code segment in the protected storage area 410b when the issued address pattern matches the predetermined address pattern or the fetched information pattern matches the predetermined information pattern. It is not easy for hackers to modify an instruction in the storage area 410a or 410c for dumping data in the microprocessor 405. Further description is detailed in the following.

Otherwise, as shown in FIG. 4B, when the check result indicates that the issued address pattern does not match the predetermined address pattern or the fetched information pattern does not match the predetermined information pattern, the decryption unit 415 directly transmits the encrypted code segment to the microprocessor 405 without decrypting the encrypted code segment. FIG. 4B is a diagram illustrating how the decryption unit 415 directly transmits the code segments in the protected storage area 410b to the microprocessor 405. Since the decryption unit 415 directly passes the encrypted code segment from the protected storage area 410b to the microprocessor 405, data buffered in the microprocessor 405 is encrypted data. Even though the hackers can modify an instruction to become a ‘data dump’ instruction for dumping data from the microprocessor 405 to an external memory 430, they are unable to know the content of the dumped code segments because the code segments are encrypted. Of course, the predetermined address pattern and predetermined information pattern can be designed carefully to ensure that hackers do not easily obtain these data patterns.

In addition, as shown in FIG. 4C, instead of directly transmitting the encrypted code segment to the microprocessor 405, the decryption unit 415 does not transmit the encrypted code segment to the microprocessor 405 when the check result indicates that the issued address pattern does not match the predetermined address pattern or the fetched information pattern does not match the predetermined information pattern. Thus, even if hackers still attempt to obtain content of the encrypted code segment from the microprocessor 405, all they will receive is random data. That is, the content of encrypted code segment(s) stored in the protected storage area is not available to the hackers.

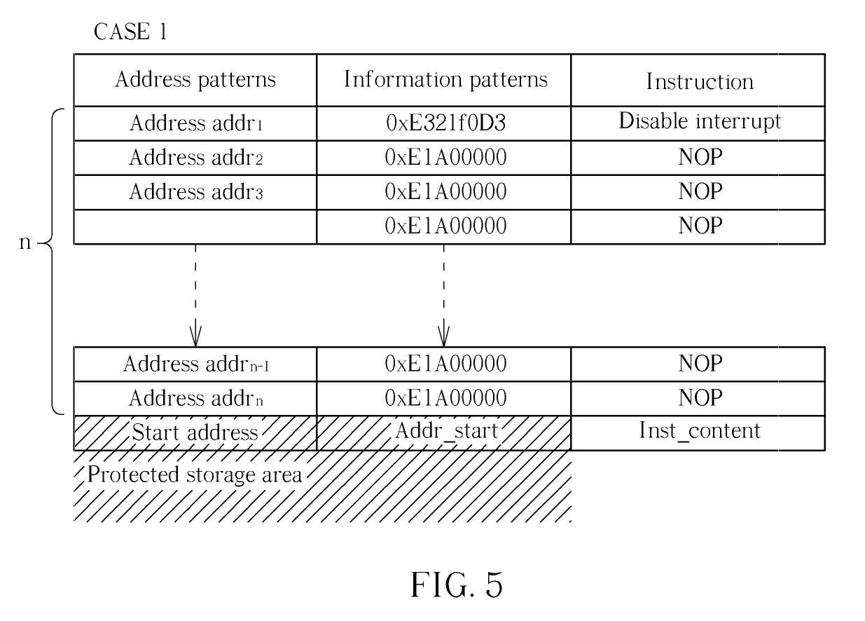

Moreover, in practice, for increasing the accuracy of the check result, the decryption unit 415 is usually arranged to check a sequence of address patterns, a sequence of information patterns, or both to generate the check result, instead of checking only one address pattern or only one information pattern. Of course, this is not meant to be a limitation of the present invention. In the following, three cases for designing the predetermined address patterns and the predetermined information patterns are provided. Please refer to FIG. 5-FIG. 7. FIG. 5-FIG. 7 respectively illustrate different examples of the predetermined address patterns and the predetermined information patterns.

In the first case, as shown in FIG. 5, the predetermined address patterns are designed to correspond, respectively, to continuous addresses Addr₁-Addrₙ. For instance, the predetermined address patterns correspond to 32 continuous addresses within the storage device 410, i.e., n equals 32, and the last address Addr₃₂ immediately precedes a start address of the protected storage area 410b. The predetermined information patterns can be designed according to design requirements. For example, the leading pattern of the predetermined information patterns, which corresponds to the leading address Addr₁, can be designed to disable an interrupt from the microprocessor 405, so the leading pattern is represented by data ‘0xE321f0D3’, as shown in FIG. 5. The purpose of the information pattern corresponding to the leading address Addr₁ is for preventing an interrupt from disturbing the check order of the predetermined address patterns. In this example, information patterns corresponding to the other addresses Addr₂-Addr₃₂ are indicative of NOP code segments; of course, the other information patterns can be indicative of other codes or other data, instead of the NOP codes. This also falls within the scope of the present invention. Please note that for an NOP code instruction the microprocessor 405 merely fetches the NOP code instruction from the storage device 410 and does not execute this instruction.

When the microprocessor 405 issues a sequence of address patterns that match the predetermined address patterns to the storage device 410 one by one, i.e., the check result indicates that the issued address patterns match the predetermined address patterns, the decryption unit 415 is enabled to decrypt encrypted code segment(s) from the protected storage area 410b and generates decrypted code segment(s) to the microprocessor 405. In this example, the decryption unit 415 is immediately enabled to decrypt an encrypted code segment at the start address of the protected storage area 410b for transmitting a decrypted code segment to the microprocessor 405. Then, the microprocessor 405 executes an instruction interpreted from the decrypted code segment. Since the protected storage area 410b does not comprise any code segment for code dump instruction and no address patterns mentioned above correspond to an instruction for code dump, the content of the encrypted code segments in the protected storage area 410b is not available to the hackers. Even if the hackers modify an instruction stored at another address external to the protected storage area 410b of the storage device 410 for code dump, they are unable to dump any decrypted code segment from the microprocessor 405 because the decrypted code segment corresponding to the start address of the protected storage area 410b is immediately executed by the microprocessor 405 after the checking. In other words, the hackers cannot place a modified instruction at an address between the address Addrₙ and the start address of the protected storage area 410b to obtain the content of any encrypted code segment.

The hackers may use two modified instructions to dump data stored in the microprocessor 405. The first instruction is used for reading code segment(s) from the protected storage area 410b to the microprocessor 405, and then the hackers control the microprocessor 405 to execute the other instruction (e.g. a ‘code dump’ instruction) for dumping buffered data. The hackers, however, are still unable to obtain the content of the encrypted code segment(s) in the protected storage area 410b since two address patterns corresponding to the two continuous instructions do not match the predetermined address patterns and the decryption unit 415 is not enabled to decrypt any code segment in the protected storage area 410b. It should be noted that the decryption unit 415 can generate the check result by checking fetched information patterns or both of the issued address patterns and fetched information patterns, as mentioned above. Moreover, in this case, even if the hackers directly modify the instruction at the address Addrₙ to try to obtain the content of any encrypted code segment, they are still unable to know the content of any encrypted code segment since this modified instruction is different from the original instruction (i.e. an NOP code segment) and the operation of the decryption unit 415 is not enabled.

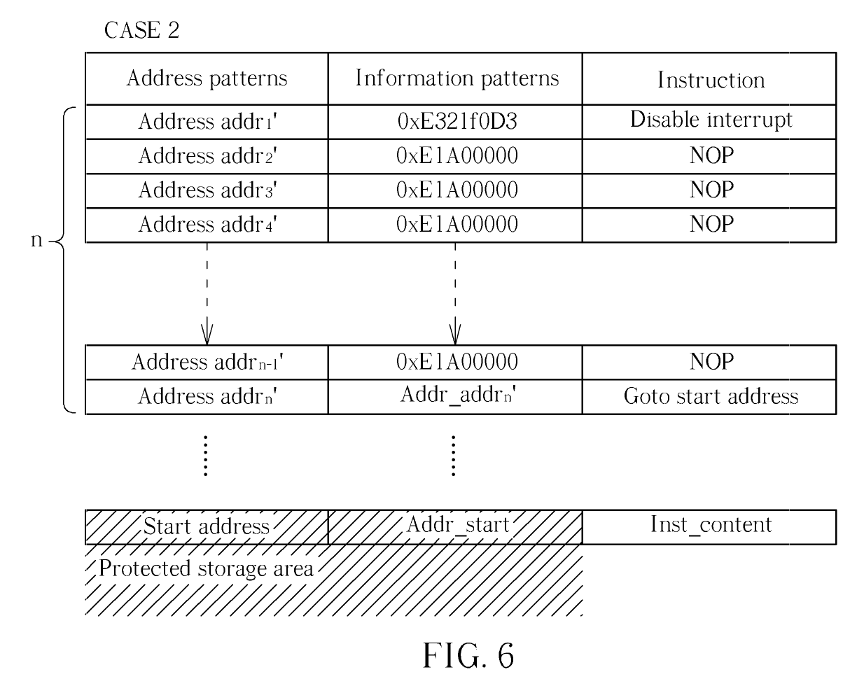

In the second case, as shown in FIG. 6, the predetermined address patterns are also designed to correspond, respectively, to continuous addresses Addr₁′-Addrₙ′. For example, the predetermined address patterns correspond to 32 continuous addresses within the storage device 410, i.e., n equals 32. A major difference between the first and second cases, however, is that the last address Addr₃₂′ does not immediately precede the start address of the protected storage area 410b. Accordingly, the last pattern of the predetermined information patterns, which corresponds to the last address Addr₃₂′, is designed to jump to the start address of the protected storage area 410b, such as a ‘Goto’ instruction. The leading pattern of the predetermined information patterns, which corresponds to the leading address Addr₁′, is also designed to disable an interrupt from the microprocessor 405. Other information patterns corresponding to the addresses Addr₂′-Addr₃₁′ are also indicative of NOP code segments; these information patterns can be indicative of other codes or other data, instead of the NOP codes. This also obeys the spirit of the present invention.

Compared to the first case, in the second case it is more difficult for the hackers to obtain content of the encrypted code segment(s). This is because they cannot easily know exactly where the continuous addresses Addr₁′-Addrₙ′ are situated in the storage device 410. Thus, it is difficult to produce a sequence of modified address patterns that match the predetermined address patterns. Further description of the decryption unit 415 is not detailed again for brevity.

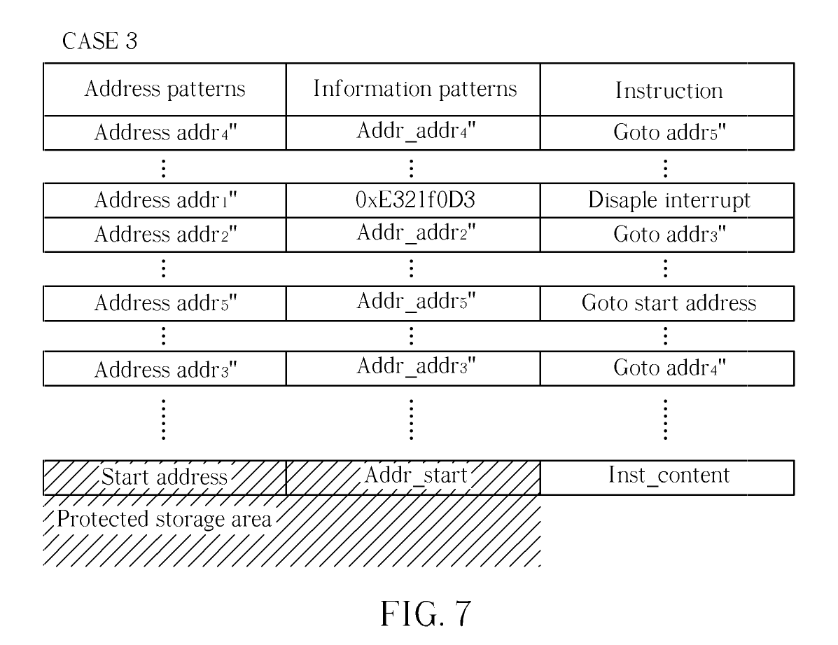

In the third case, as shown in FIG. 7, not all the predetermined address patterns are designed to correspond to continuous addresses in the storage device 410. For instance, it is assumed that the predetermined address patterns comprise five (for illustrative purposes) address patterns Addr₁″-Addr₅″; of course, the number of the address patterns is not intended to be a limitation of the present invention. An information pattern corresponding to the leading address Addr₁″ is also used for disabling an interrupt from the microprocessor 405, and an information pattern corresponding to the last address Addr₅″ is indicative of a ‘Goto’ instruction for jumping to the start address of the protected storage area 410b. The information patterns corresponding to the addresses Addr₂″, Addr₃″, and Addr₄″ are also used for jumping to, respectively, the addresses Addr₃″, Addr₄″, and Addr₅″. Compared to the first and second cases, since the addresses Addr₁″-Addr₅″ are not continuous addresses, it is very difficult for the hackers to produce the same address patterns. In other words, once the decryption unit 415 receives a sequence of issued address patterns that match the predetermined address patterns and correspond to the addresses Addr₁″-Addr₅″ in order, the decryption unit 415 is enabled to decrypt encrypted code segment(s) in the protected storage area 410b of the storage device 410. Of course, the decryption unit 415 can generate the check result by checking a sequence of fetched information patterns corresponding to the issued address patterns only, or both the issued address patterns and fetched information patterns.

Furthermore, the last addresses in the three cases, i.e., Addrₙ, Addrₙ′, and Addrₙ″, are not limited to be used for jumping to the start address of the protected storage area 410b. The addresses Addrₙ, Addrₙ′, and Addrₙ″ can be designed to jump to another address of the protected storage area 410b. Besides, the microprocessor 405 comprises a debug interface for debugging. To prevent the hackers from retrieving the decrypted codes segment(s) buffered in the microprocessor 405 via the debug interface, the microprocessor 405 disables the debug interface when the above-mentioned check result indicates that the address patterns issued by the microprocessor 405 match the predetermined address patterns or the fetched information patterns match the predetermined information patterns.

In implementation, the operation of the decryption unit 415 can be implemented by using a de-entropy unit or a descramble unit. Additionally, through the check operation of the decryption unit 415 for the issued address patterns, the fetched information patterns, or both, the security system 400 is capable of providing a security scheme, which is similar to a trust zone structure of a high-end security system.

Furthermore, as mentioned above, the check result is generated according to the signal communicated between the microprocessor 405 and the storage device 410; this signal is at least an address pattern or at least an information pattern. In other embodiments, a control signal issued by a microprocessor to a storage device can be used as a reference for generating a check result. That is, under this condition, a decryption unit checks whether the issued control signal matches a predetermined control signal or not, to generate a check result. Then, the decryption unit 415 decides whether to perform decryption or not, based on the generated check result. This also obeys the spirit of the present invention.

Those skilled in the art will readily observe that numerous modifications and alterations of the device and method may be made while retaining the teachings of the invention.

What is claimed is:

1. A security system for code dump protection, comprising:
a storage device having a protected storage area, the protected storage area storing at least an encrypted code segment;
a processor, for issuing at least one address pattern to the storage device for obtaining at least one information pattern corresponding to the address pattern; and
a decryption unit, coupled between the processor and the storage device;
wherein the decryption unit checks signal communicated between the processor and the storage device to generate a check result, and determines whether to decrypt the encrypted code segment in the protected storage area to generate a decrypted code segment to the processor according to the check result.

2. The security system of claim 1, wherein the decryption unit checks the address pattern to generate the check result, wherein the address pattern comprises a pattern of an address or a pattern of an address header.

3. The security system of claim 2, wherein the processor issues a sequence of address patterns to the storage device for requesting a sequence of information patterns stored at continuous addresses of the storage device, and the decryption unit checks the sequence of address patterns to generate the check result.

4. The security system of claim 3, wherein a last address of the continuous addresses immediately precedes a start address of the protected storage area.

5. The security system of claim 3, wherein an information pattern corresponding to a leading address pattern of the sequence of address patterns is an instruction pattern used for disabling an interrupt when executed by the processor.

6. The security system of claim 5, wherein an information pattern corresponding to a last address pattern of the sequence of address patterns is an instruction pattern used for jumping to a start address of the protected storage area when executed by the processor.

7. The security system of claim 2, wherein the processor issues a sequence of address patterns to the storage device for requesting a sequence of information patterns stored at addresses of the storage device, not all of the addresses are continuous, and the decryption unit checks the sequence of address patterns to generate the check result.

8. The security system of claim 7, wherein an information pattern corresponding to a leading address pattern of the sequence of address patterns is an instruction pattern used for disabling an interrupt when executed by the processor.

9. The security system of claim 8, wherein an information pattern corresponding to a last address pattern of the sequence of address patterns is an instruction pattern used for jumping to a start address of the protected storage area when executed by the processor.

10. The security system of claim 1, wherein the decryption unit checks the information pattern to generate the check result, wherein the information pattern comprises an instruction pattern or a data pattern.

11. The security system of claim 1, wherein:
when the check result indicates that the signal communicated between the processor and the storage device matches a predetermined pattern, the decryption unit decrypts the encrypted code segment; and
when the check result indicates that the signal communicated between the processor and the storage device does not match the predetermined pattern, the decryption unit either directly transmits the encrypted code segment to the processor without decrypting the encrypted code segment, or does not transmit the encrypted code segment to the processor.

12. The security system of claim 1, wherein the processor comprises a debug interface for debugging, and the processor disables the debug interface when the check result indicates that the signal communicated between the processor and the storage device matches a predetermined pattern.

13. A security method for code dump protection to a security system, comprising:
(a) providing a storage device having a protected storage area, the protected storage area storing at least an encrypted code segment;
(b) utilizing a processor to issue at least one address pattern to the storage device for obtaining at least one information pattern corresponding to the address pattern;
(c) checking signal communicated between the processor and the storage device to generate a check result; and
(d) determining whether to decrypt the encrypted code segment in the protected storage area to generate a decrypted code segment to the processor according to the check result.

14. The security method of claim 13, wherein step (c) comprises: checking the address pattern to generate the check result; wherein the address pattern comprises a pattern of an address or a pattern of an address header.

15. The security method of claim 14, wherein step (b) comprises:
issuing a sequence of address patterns to the storage device for requesting a sequence of information patterns stored at continuous addresses of the storage device; and step (c) comprises:
checking the sequence of address patterns to generate the check result.

16. The security method of claim 15, wherein a last address of the continuous addresses immediately precedes a start address of the protected storage area.

17. The security method of claim 15, wherein an information pattern corresponding to a leading address pattern of the sequence of address patterns is an instruction pattern used for disabling an interrupt when executed by the processor.

18. The security method of claim 17, wherein an information pattern corresponding to a last address pattern of the sequence of address patterns is an instruction pattern used for jumping to a start address of the protected storage area when executed by the processor.

19. The security method of claim 14, wherein step (b) comprises:
issuing a sequence of address patterns to the storage device for requesting a sequence of information patterns stored at addresses of the storage device, wherein not all of the addresses are continuous; and
step (c) comprises:
checking the sequence of address patterns to generate the check result.

20. The security method of claim 1 9, wherein an information pattern corresponding to a leading address pattern of the sequence of address patterns is an instruction pattern used for disabling an interrupt when executed by the processor.

21. The security method of claim 20, wherein an information pattern corresponding to a last address pattern of the sequence of address patterns is an instruction pattern used for jumping to a start address of the protected storage area when executed by the processor.

22. The security method of claim 13, wherein step (c) comprises:
checking the information pattern to generate the check result, wherein the information pattern comprises an instruction pattern or a data pattern.

23. The security method of claim 13, wherein step (d) comprises:
when the check result indicates that the signal communicated between the processor and the storage device matches a predetermined pattern, decrypting the encrypted code segment; and
when the check result indicates that the signal communicated between the processor and the storage device does not match the predetermined pattern, either directly transmitting the encrypted code segment to the processor without decrypting the encrypted code segment, or not transmitting the encrypted code segment to the processor.

24. The security method of claim 13, wherein the processor comprises a
debug interface for debugging, and the method further comprises:
disabling the debug interface when the check result indicates that the signal communicated between the processor and the storage device matches a predetermined pattern.
